(19) United States
(12) Patent Application Publication
(10) Pub. No.: US 2011/0124117 A1
(43) Pub. Date: May 26, 2011

(54) SERS NANOTAG ASSAYS WITH ENHANCED ASSAY KINETICS

(75) Inventors: William E. Doering, Santa Clara, CA (US); Rebecca Stoermer Golightly, Belmond, CA (US)

(73) Assignee: Becton, Dickinson and Company, Franklin Lakes, NJ (US)

(21) Appl. No.: 12/665,379

(22) PCT Filed: Jun. 30, 2008
(86) PCT No.: PCT/US2008/068813

§ 371 Date: Nov. 8, 2010

Related U.S. Application Data
(60) Provisional application No. 60/947,262, filed on Jun. 29, 2007.

(51) Int. Cl. G01J 3/44

(52) U.S. Cl. 436/501; 356/301

(57) ABSTRACT

Methods and systems for the use of surface-enhanced Raman scattering nanotags (SERS nanotags) in various assay platforms which feature accelerated reaction kinetics. One embodiment includes a method detecting a substance of interest by associating a SERS nanotag with the substance of interest while accelerating the reaction kinetics of the association steps. This method also includes detecting a Raman spectrum of a reporter molecule associated with the SERS nanotag. The reaction kinetics of the assay may be accelerated by applying microwave radiation to the sample, heating the sample, agitating the sample, mixing the sample, vibrating the sample or other methods.

### TECHNICAL FIELD

The present invention is directed toward a method and system for the use of Surface Enhanced Raman Scattering nanotags (SERS nanotags) to create a variety of assay platforms with enhanced assay kinetics.

### BACKGROUND

Particles are extensively used in diagnostic assays as solid phase capture or detection species. Microparticle-based assays can be divided into two main categories: homogeneous (separation-free) and heterogeneous assays.

In a homogeneous (separation-free) assay format, binding reactants are mixed and measured without any subsequent washing step prior to detection. The advantages of such a system are a simple assay format, simpler instrumentation as well as lower costs because of fewer assay steps, low volumes and low waste. Homogeneous immunoassays do not require physical separation of bound and free analyte and thus may be faster and easier to perform then heterogeneous immunoassays. Homogeneous assays are the preferred assay format in high throughput screening platforms such as AlphaScreen, SPA, fluorescent polarization and flow cytometry based assays, as well as in diagnostic assays such as particle agglutination assays with nephelometry or turbidimetry as the detection methods.

Heterogeneous immunoassays requiring the separation of free analyte and of unbound detector and in certain instances may be more versatile than homogeneous assays. The wash or physical separation steps eliminate most interfering substances and in general do not interfere with the detection/quantification step. Stepwise heterogeneous assays are possible which allow for larger sample size, which in turn improves sensitivity and yields wider dynamic range than the standard assay curves. The disadvantages of heterogeneous immunoassays are that they are much more labor-intensive, time-consuming and typically require dedicated analyzers. In addition, automated heterogeneous systems require more complicated designs or multiple instruments to accommodate wash and separation steps. Many clinical analyzers use magnetic microparticles for heterogeneous diagnostic assays to selectively bind and then separate the analyte of interest from its surrounding matrix using a magnetic field.

Assays designed to shorten the time from sampling to diagnosis are important in emergency room and point-of-care settings. Typical immunoassays may require a 30-minute or greater incubation time if assay kinetics are allowed to proceed at room temperature from initial mixing through completion of all reactions associated with the assay.

The present invention is directed toward overcoming one or more of the problems discussed above.

### SUMMARY OF THE EMBODIMENTS

Several methods and systems are disclosed for the use of surface-enhanced Raman scattering nanotags (SERS nanotags) in various assay platforms which feature accelerated reaction kinetics. One embodiment includes a method detecting a substance of interest by associating a SERS nanotag with the substance of interest while accelerating the reaction kinetics of the association steps. This method also includes detecting a Raman spectrum of a reporter molecule associated with the SERS nanotag. The reaction kinetics of the assay may be accelerated by applying microwave radiation to the sample, heating the sample, agitating the sample, mixing the sample, vibrating the sample or other methods.

Alternative embodiments include any type of immunoassay or other assay platform where a SERS nanotag particle is bound, associated with or otherwise conjugated to an analyte or a molecule capable of binding an analyte or a capture particle. The assay platform may be configured so that the binding, capture, association or other reaction kinetics may be accelerated as described above.

Another alternative embodiment includes a kit having an assay platform as described above plus an apparatus suitable for accelerating reaction kinetics such as a portable microwave device, laser or suitably sized oven. The kit may also include integrated or separate detection means such as a Raman spectroscope or Raman microscope.

### BRIEF DESCRIPTION OF THE DRAWINGS

FIG. 1 is a schematic diagram of a SERS nanotag suitable for implementation of select embodiments of the present invention;

FIG. 2 is a graphic comparison of the SERS spectra of SERS nanotags having five different reporter molecules;

FIG. 3 is a schematic illustration of an assay consistent with the present invention;

FIG. 4 is a graphic representation of a standard curve generated using the assay of FIG. 3 and microwave energy to accelerate reaction kinetics; and

FIG. 5 is a graphic representation of a standard curve generated using the assay of FIG. 3 with no acceleration of reaction kinetics.

### DETAILED DESCRIPTION OF THE EMBODIMENTS

### A. General Discussion of SERS Nanotags for Biological Assays

Many assay platforms feature a two particle or multiple particle capture system. For example, in one non-exclusive type of sandwich inmmunoassay, a capture particle is conjugated with an antibody to capture the antigen of interest from a biological sample. The detection particle, which may be a SERS-nanotag detection particle as described below, is also conjugated with a detection antibody having binding affinity for the antigen of interest. In the presence of the antigen of interest both the capture particle and the detection particle are bound to form a SERS active, 2-particle immunocomplex. The time necessary to obtain results from a sandwich immunoassay as described above is dictated in large part by the time necessary to complete the binding reactions between the conjugated capture and detection particles and the antigen of interest. In many instances, room temperature reaction kinetics dictate that 30 minutes or more are required for completion of the binding reactions. The embodiments disclosed herein include methods and assay platforms where the time for binding or other reactions is decreased by accelerating reaction kinetics.

Reaction kinetics may be accelerated by heating the sample, agitating the sample, mixing the sample, vibrating the sample or otherwise energizing the sample. As described in detail below, subjecting the sample to microwave radiation may be particularly useful for increasing reaction kinetics without unnecessary sample heating. Thus, reaction kinetics may be accelerated by microwaving the sample, placing the sample under infrared light energy, applying acoustic energy to the sample, heating the sample in a conventional oven, stimulating the sample with laser light or otherwise energizing the sample. These alternative acceleration techniques do not all achieve the same results.

The methods and assay platforms described herein are suitable for implementation with many types of assay which feature a SERS nanotag detection particle. For example, certain assays are disclosed in co-pending patent application no. PCT/US07/61878 entitled “SERS NANOTAG ASSAYS” and co-pending international patent application no. PCT/US08/60871 entitled “SERS NANOTAG ASSAYS”, which pending applications are incorporated herein by reference in their entirety, and made a part hereof with respect to the various types of assay which can be implemented using one or more SERS nanotag detection particles. The disclosed and similar assays may have their respective reaction kinetics accelerated and the overall time necessary to perform the assays shortened by utilizing the techniques described herein.

SERS nanotags offer at least five intrinsic advantages as detection tags. (1) They can be excited in the near-IR, and thus are compatible with whole blood measurement. (2) SERS nanotags resist photobleaching which allows for higher laser powers and longer data acquisition times, resulting in more sensitive measurements. (3) A large number of distinct tags exist, enabling highly multiplexed assays. (4) SERS nanotags are durable and do not degrade upon the application of microwave, heat or other mechanical energy. (5) The encapsulent of a SERS Nanotag as described below may insulate the metal core from other assay components which may provide advantages in an assay with accelerated reaction kinetics.

### B. General Information Regarding SERS Nanotags

SERS nanotags are novel, nanoparticulate optical detection tags based on surface enhanced Raman scattering (SERS) (Mulvaney et al. (2003) Langmuir 19:4784-4790; Natan, U.S. Pat. No. 6,514,767). Raman scattering (Long (2002) The Raman Effect; A Unified Treatment of the Theory of Raman Scattering by Molecules. John Wiley & Sons Ltd, Chichester; Modern Techniques in Raman Spectroscopy (1996) John Wiley & Sons Ltd, Chichester; Analytical Applications of Raman Spectroscopy (1999) Blackwell Science Ltd, Malden, Mass.) SERS is a laser-based optical spectroscopy that, for molecules, generates a fingerprint-like vibrational spectrum with features that are much narrower than typical fluorescence. Raman scattering can be excited using monochromatic far-red or near-IR light, photon energies which are too low to excite the inherent background fluorescence in biological samples. Since Raman spectra typically cover vibrational energies from 300-3500 cm⁻¹, t could be possible to measure a dozen (or more) tags simultaneously, all with a single light source. However, normal Raman spectra are very weak, limiting utility for bioanalytical chemistry. In SERS, molecules in very close proximity to nanoscale roughness features on noble metal surfaces (gold, silver copper) give rise to million- to trillion-fold increases [known as enhancement factor (EF)] in scattering efficiency (Moskovits (1985) Rev. Mod. Phys. 57:783-826; Otto et al. (1992) J. Phys. Cond. Mat. 4:1143-1212; Campion and Kambhampati (1998) Chem. Soc. Rev. 27:241-249; Tian et al. (2002) J. Phys. Chem. B 106:9463-9483; CAS Online Search, April 2004), More importantly, SERS can also be used to detect molecules adsorbed to individual metal nanoparticles (Emory et al. (1998) J. Am. Chem. Soc. 120:8009-8010; Moyer et al. (2000) J. Am. Chem. Soc. 122:5409-5410), and has been used to demonstrate detection of single molecules (Nie and Emory (1997) Science 275:1102-1106; Kneipp et al. (1997) Phys. Rev. Lett. 78:1667-1670; Michaels et al. (1999) J. Am. Chem. Soc. 121:9932-9939; Xu et al. (1999) Phys. Rev. Lett. 83:4357-4360; Goulet et al. (2003) Anal. Chem. 75:1918-1923).

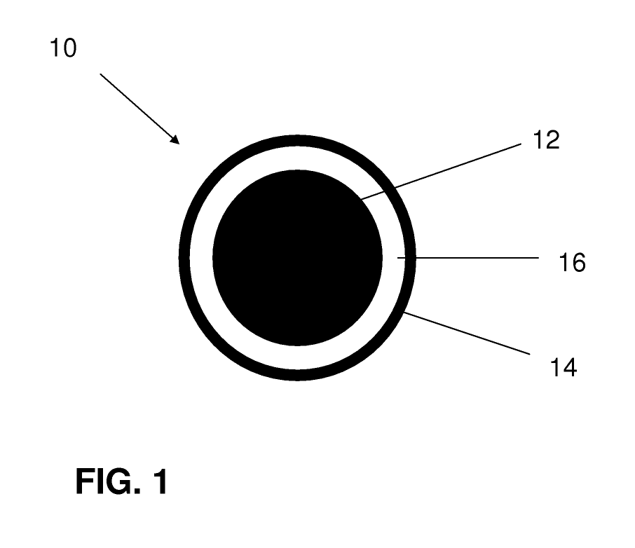

A typical SERS nanotag 10 is shown in FIG. 1. The illustrated SERS nanotag 10 includes a metal nanoparticle core 12, and a SiO₂ (glass) shell 14. Other materials including but not limited to various types of polymers may also be used as an encapsulant or shell consistent with the present invention. Details concerning the use, manufacture and characteristics of a typical SERS nanotag are included in U.S. Pat. No. 6,514,767, entitled “Surface Enhanced Spectroscopy-Active Composite Nanoparticles,” which patent is incorporated herein by reference for the specific teaching of the use, manufacture and characteristics of a SERS nanotag. Although the invention is described in terms of SERS nanotags prepared from single nanoparticle cores 12, it is to be understood that nanoparticle core clusters or aggregates may be used in the preparation of SERS nanotags. Methods for the preparation of clusters of aggregates of metal colloids are known to those skilled in the art. The use of sandwich-type particles as described in U.S. Pat. No. 6,861,263, is also contemplated, which patent is incorporated herein by reference for the specific teaching of the use, manufacture and characteristics of sandwich-type particles.

The nanoparticle core 12 may be of any material known in the art to be Raman-enhancing. The nanoparticle cores 12 may be isotropic or anisotropic. Anisotropic nanoparticles may have a length and a width. In some embodiments, the length of an anisotropic nanoparticle is the dimension parallel to the aperture in which the nanoparticle was produced. In the case of anisotropic nanoparticles, in some embodiments, the nanoparticle has a diameter (width) of 350 nm or less. In other embodiments, the nanoparticle has a diameter of 250 nm or less and in some embodiments, a diameter of 100 nm or less. In some embodiments, the width is between 15 nm to 300 nm. In some embodiments, the nanoparticle has a length of about 10-350 nm.

Nanoparticles suitable to be the core of a SERS nanotag include colloidal metal, hollow or filled nanobars, magnetic, paramagnetic, conductive or insulating nanoparticles, synthetic particles, hydrogels (colloids or bars), and the like. The nanoparticles used in the present invention can exist as single nanoparticles, or as clusters or aggregates of the nanoparticles.

It will be appreciated by one of ordinary skill in the art that nanoparticles can exist in a variety of shapes, including but not limited to spheroids, rods, disks, pyramids, cubes, cylinders, nanohelixes, nanosprings, nanorings, rod-shaped nanoparticles, arrow-shaped nanoparticles, teardrop-shaped nanoparticles, tetrapod-shaped nanoparticles, prism-shaped nanoparticles, and a plurality of other geometric and non-geometric shapes. Another class of nanoparticles that has been described include those with internal surface area. These include hollow particles and porous or semi-porous particles. Moreover, it is understood that methods to prepare particles of these shapes, and in certain cases to prepare SERS-active particles of these shapes, have been described in the literature. While it is recognized that particle shape and aspect ratio can affect the physical, optical, and electronic characteristics of nanoparticles, the specific shape, aspect ratio, or presence/absence of internal surface area does not bear on the qualification of a particle as a nanoparticle.

A nanoparticle also includes a nanoparticle in which the metal includes an additional component, such as in a core-shell particle. For example, Ag core/Au shell particles, like those described in J. Am. Chem. Soc. 2001, 123, 7961, or Au core/Ag shell particles, or any core-shell combination involving SERS-active metals, can be used. Other combinations suitable for use in core-shell particles are included in this invention, such as Au- or Ag-nanoparticle functionalized silica/alumina colloids, Au- or Ag-functionalized TiO₂ colloids, Au nanoparticle capped-Au nanoparticles (see, for example, Mucic, et al., J. Am. Chem. Soc. 1998, 120, 12674), Au nanoparticle-capped TiO₂ colloids, particles having and Si core with a metal shell (“nanoshells”), such as silver-capped SiO₂ colloids or gold-capped SiO₂ colloids. (See, e.g. Jackson, et al., 2004 Proc Natl Acad Sci USA. 101(52):17930-5; Talley, et al., Nano Letters (2005)). Hollow nanoparticles such as hollow nanospheres and hollow nanocrystals may also be utilized in the SERS nanotags.

Each SERS nanotag is encoded with a unique reporter 16, comprising an organic or inorganic molecule at the interface between the nanoparticle core and shell of glass or other suitable encapsulant. This approach to detection tags leverages the strengths of Raman scattering as a high-resolution molecular spectroscopy tool and the enhancements associated with SERS, while bypassing the shortcomings often encountered when making stand alone SERS substrates such as difficult reproducibility and lack of selectivity. SERS nanotags exhibit intense spectra (enhancement factors in excess of 10⁶) with the 633 and 785 nm excitation wavelengths that are excellent for avoiding intrinsic background fluorescence in biological samples such as whole blood and in matrices like glass and plastic. The glass coating, which is essentially SERS-inactive, stabilizes the particles against aggregation, prevents the reporter from diffusing away, prevents competitive adsorption of unwanted species, and provides an exceptionally well-established surface to which biomolecules can be conjugated for bioassay development (Aslam and Dent (1998) Bioconjugation: Protein Coupling Techniques for the Biomedical Sciences. Grove's Dictionaries Inc, New York, N.Y.).

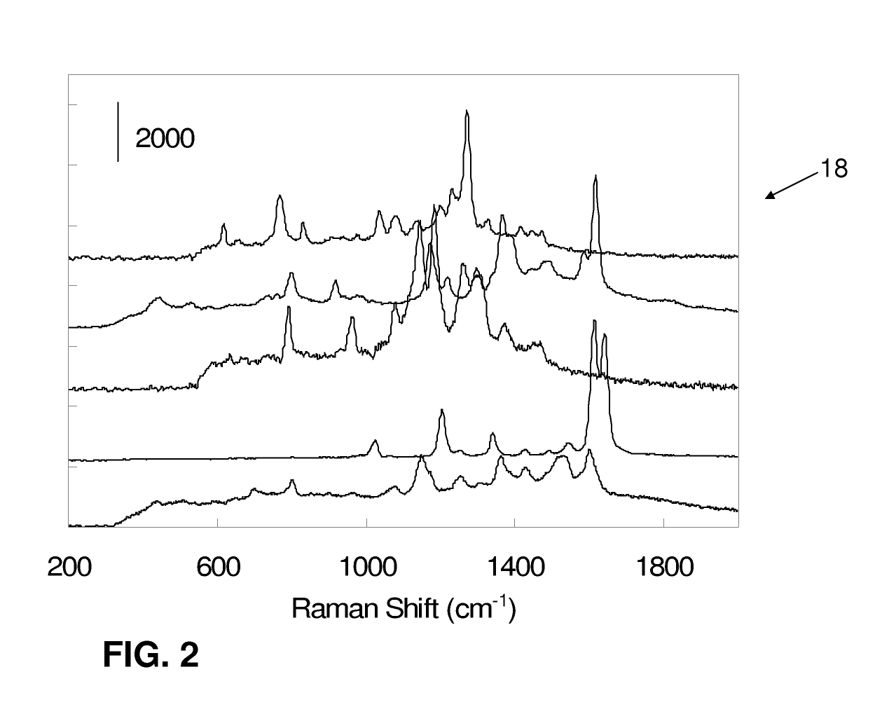

Multiple unique flavors of tags are available. FIG. 2 shows a graph 18 of the spectra of five unique SERS tags, with clearly differentiated features, which can be utilized for a multiplexed assay. In a multiplexed assay, a single spectrum will be acquired, and it will be necessary to quantitatively separate that spectrum into its components. For spectra deconvolution and quantification of the individual components an enhanced commercial software package may be used to carry out a linear least squares analysis using pure spectra from each tag as a standard.

A Representative Immunoassay with Accelerated Reaction Kinetics.

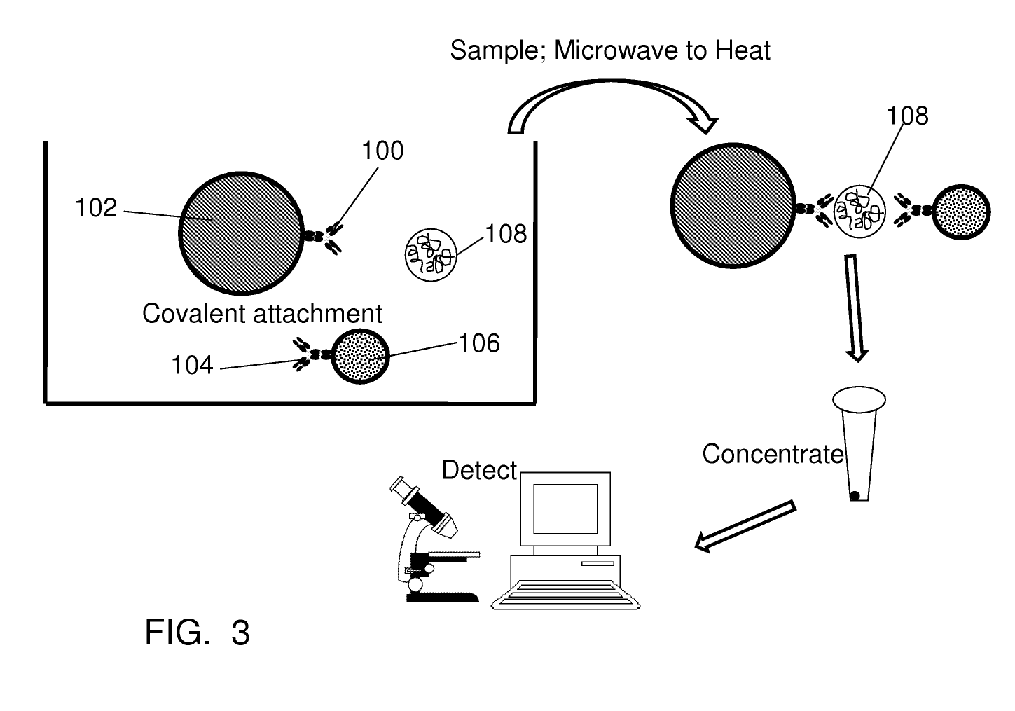

The present invention is not limited to the sandwich immunoassay described herein in detail. As described above, any assay which uses SERS detection tags may benefit from the techniques disclosed for accelerating reaction kinetics. FIG. 3 thus schematically illustrates only one of many possible representative assay formats. In the FIG. 3 assay, a capture antibody 100 is covalently attached to a magnetic particle 102 and the detection antibody 104 is covalently attached to a SERS nanotag 106. Both capture and detection particles are loaded into a vessel, for example a polypropylene tube (pre-diluted with the appropriate dilution buffer) followed by the sample. An antigen associated with a chemical, protein or substance of interest 108 causes the formation of a 2-particle immunocomplex by binding with the capture and detection particles. As is described in Example 1 below, the incubation period for the immunoassay of FIG. 3 can be as long as 30 minutes if the assay is carried out under room temperature conditions with no additional energy input other than simple mixing such as placement of the assay tube on an end over end mixing wheel. On the contrary, microwaving the sample as described in Example 1 below provides for meaningful assay results in as little time as 30 seconds.

The SERS detection tags described in detail above feature a SERS-enhancing metallic core. This core may be of gold, silver, copper, an alloy or other material which is Raman-enhancing. Research by Aslan, et al. indicates that unencapsulated gold colloids in an assay solution absorb and dissipate electromagnetic energy at high microwave frequencies (greater than 8 GHz) with minimal bulk heating due to the minimal absorption of the high frequency microwave radiation by water. Microwave-Accelerated Ultrafast Nanoparticle Aggregation Assays Using Gold Colloids, Aslan, et al., Analytical Chemistry, 2007, pp. A-F. The Aslan article is incorporated herein by reference in its entirety attached hereto. Thus, the research by Aslan indicates that the decrease in the time required to complete a microwave-accelerated assay is due to factors other than bulk heating. Possibly, the microwave energy directly impacts kinetic energy to the gold colloid, and therefore directly accelerates binding events. Accordingly, conventional heating may accelerate an assay reaction somewhat, but the overall increase in assay reaction speed is not expected to be as dramatic when conventional heating methods are compared to the application of microwave energy. It is hypothesized by Aslan that the increase in metal colloid kinetic energy is the result of microwave-induced dipole torque.

Readily available conventional microwave ovens generate microwaves at 2.45 GHz, a frequency which is absorbed by water molecules making these microwave frequencies quite useful for cooking. 2.45 GHz microwave energy will thus directly heat the water-based solution in which an assay may be performed. The potentially undesirable heating of an assay solution might be minimized by the use of a microwave source generating energy at a frequency other than 2.45 GHz. For example, Aslan indicates that microwave energy at 12 GHz can accelerate the macro molecular aggregation of a gold colloid based assay with 99.99% of the microwave energy being absorbed by the colloids, since water does not absorb electromagnetic energy at the 12 GHz frequency.

The SERS nanotags used in the assays of the present invention are particularly well-suited for use in the presence of microwave radiation. In particular, the nanotag encapsulent, which is often a glass shell, typically will not absorb any of the microwave radiation. Thus, the glass shell or other encapsulent may provide an insulation barrier between the metal nanoparticle core and the bulk assay solution. Localized heating of the assay solution may be minimized. Similarly, a higher powered microwave source may be used to enhance assay kinetics while maintaining the same overall assay temperature gain as experienced with a gold colloid based assay and a lower powered source.

In addition, any necessary antibody may be covalently attached to the shell of a SERS nanotag. This may be contrasted with the passive attachment mechanisms typically employed between the antibody and metal surface of a colloid based assay. The covalent link possible with a SERS nanotag is substantially more durable than a passive attachment mechanism. Therefore, a SERS nanotag based assay is more likely to remain fully effective in the presence of microwaves, heat or other energizing sources.

### EXAMPLES

The following examples are provided for illustrative purposes only and are not intended to limit the scope of the invention.

### Example 1

A master mix of magnetic particles (Bioclone lot 4) was conjugated with cTnI capture antibodies. In addition, SERS tags were conjugated with cTnI capture antibodies. A diluent of 5% BSA, 0.5% Tween, 0.5× Pierce Protein Free (PBS) blocking buffer and 0.5% PEG was prepared in the following quantities:
Magnetic particles (10 mg/ml)=67.5 μL
SERS tags (64.1 OD)=4.3 μL
Diluent=48.6 μL

62 μl of mastermix was added to each of (7) 0.2 μl Axygen tubes as well as 100 μl of cTnI antibody at the following concentrations:

a. 100 ng/mL;

b. 33 ng/mL;

c. 11 ng/mL;

d. 3 ng/mL;

e. 1 ng/mL;

f. 0.03 ng/mL;

g. 0 ng/mL.

The tubes were placed in a black plastic 96 well tray holder and were placed in a microwave (Sharp Carousel Model # R-204CW; 2.45 GHz) at high power for 10 seconds. The tubes were removed from the microwave, inverted to mix for 2-5 sec and placed back into the microwave for an additional 10 seconds. The inverting and microwaving steps were repeated for a total of 3 times (30 seconds total time in the microwave) before the assay was analyzed on a Raman spectrum reader. Three separate 10 second microwave cycles were selected to keep the sample caps from pressurizing and opening in the microwave, which was suspected to happen if the samples were heated continuously. A typical cTnI assay which is not microwaved or otherwise subjected to steps to increase reaction kinetics, is mixed on a rotator at room temperature for 30 minutes prior to measuring results.

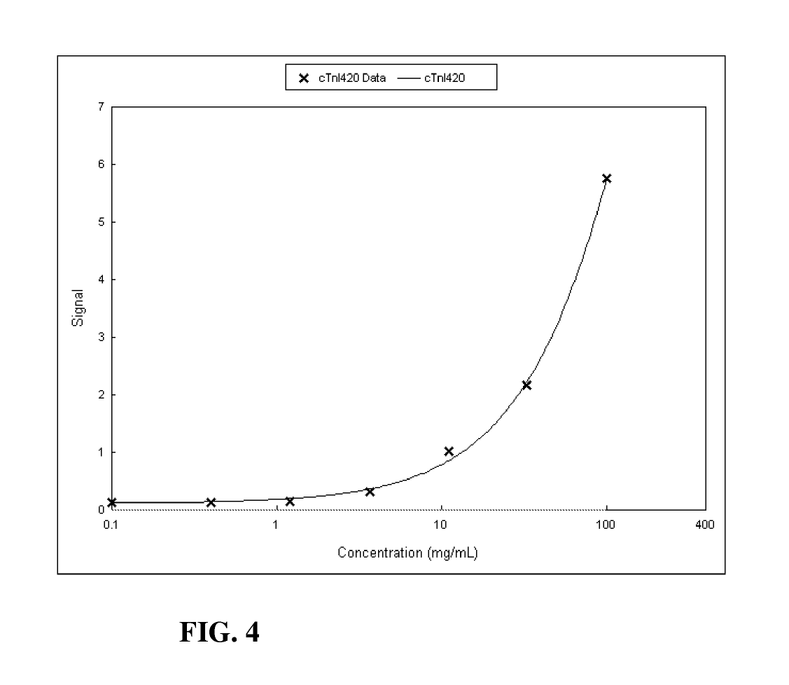

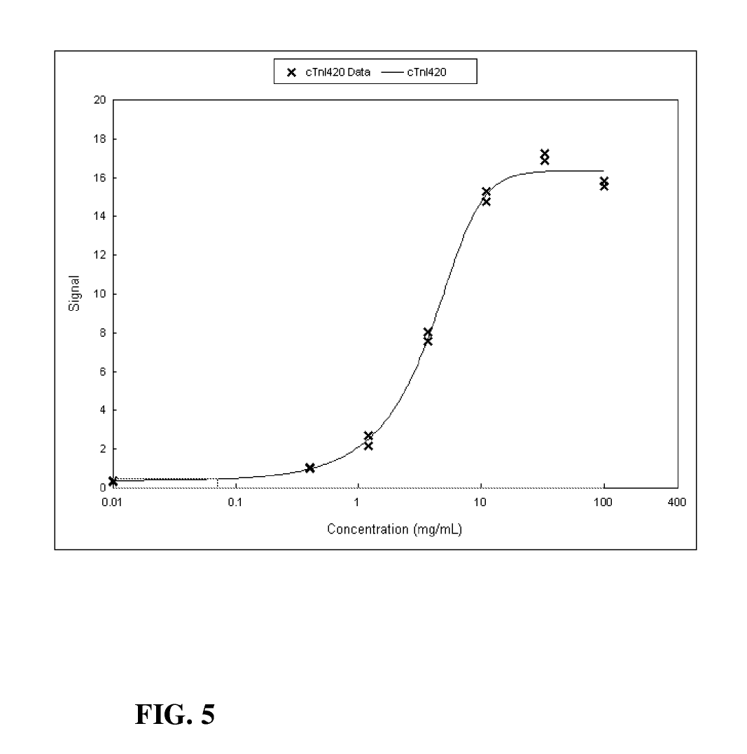

Results from the assay featuring the use of microwave energy to increase reaction kinetics are shown in FIG. 4. The graph of FIG. 4 illustrates a standard curve which increases with increasing amounts of protein. The results of the microwave accelerated assay may be compared with the results of a conventional assay (FIG. 5) where no steps were taken to accelerate reaction kinetics and incubation proceeded for 30 minutes at room temperature. The microwaved standard curve is somewhat suppressed when compared to the same assay performed with a 30 minute incubation. It was also noted that the microwaved samples contained an egg white-looking film in the tube, most likely due to cooked albumin from the BSA in the buffer. Results may be enhanced upon buffer selection and optimizing the microwaving or other energizing times.

What is claimed is:

1. A method of detecting a substance of interest comprising:
associating a SERS nanotag with the substance of interest while accelerating the association reaction kinetics; and
detecting a Raman spectrum of a reporter molecule associated with the SERS nanotag.

2. The method of claim 1 wherein the association reaction kinetics are accelerated by at least one of the following methods; subjecting the sample to microwave radiation, heating the sample, agitating the sample, mixing the sample and vibrating the sample.

3. The method of claim 2 wherein the association reaction kinetics are accelerated by subjecting the sample to microwave radiation having a frequency of greater than 2.45 GHz.

4. The method of claim 2 wherein the association reaction kinetics are accelerated by subjecting the sample to microwave radiation having a frequency of greater than 8.0 GHz.

5. A method for detecting an analyte of interest comprising:
providing capture particles conjugated with a first molecule capable of selectively binding said analyte;
providing SERS nanotag detection particles conjugated with a second molecule capable of selectively binding said analyte;
contacting a sample which may contain the analyte of interest with the capture and detection particles;
accelerating binding reaction kinetics within the sample thereby forming a 2-particle complex from capture particles and detection particles bound to the analyte;
concentrating the 2 particle complex; and
detecting the Raman spectrum of a Raman reporter molecule associated with the SERS nanotag.

6. The method of claim 5 wherein the binding reaction kinetics are accelerated by at least one of the following methods; subjecting the sample to microwave radiation, heating the sample, agitating the sample, mixing the sample and vibrating the sample.

7. The method of claim 5 wherein the association reaction kinetics are accelerated by subjecting the sample to microwave radiation having a frequency of greater than 2.45 GHz.

8. The method of claim 5 wherein the association reaction kinetics are accelerated by subjecting the sample to microwave radiation having a frequency of greater than 8.0 GHz.

9. A method of detecting an analyte of interest comprising:
providing capture particles conjugated with a first molecule capable of selectively binding said analyte;
providing SERS nanotag detection particles derivatized with said analyte;
contacting a sample which may contain the analyte of interest with the capture and SERS nanotag detection particles;
accelerating binding reaction kinetics within the sample thereby forming both an analyte/capture particle complex and a SERS nanotag detection particle/capture particle complex;
concentrating the capture particle complexes; and
detecting the Raman spectrum of a Raman reporter molecule associated with the SERS nanotag detection particles.

10. The method of claim 9 wherein the binding reaction kinetics are accelerated by at least one of the following methods; subjecting the sample to microwave radiation, heating the sample, agitating the sample, mixing the sample and vibrating the sample.

11. The method of claim 10 wherein the association reaction kinetics are accelerated by subjecting the sample to microwave radiation having a frequency of greater than 2.45 GHz.

12. The method of claim 10 wherein the association reaction kinetics are accelerated by subjecting the sample to microwave radiation having a frequency of greater than 8.0 GHz.

13. A method of detecting an analyte of interest comprising:
providing capture particles derivatized with said analyte;
providing SERS nanotag detection particles conjugated with a first molecule capable of selectively binding said analyte;
contacting a sample which may contain the analyte of interest with the capture and SERS nanotag detection particles;
accelerating binding reaction kinetics within the sample thereby forming both an analyte/SERS nanotag detection particle complex and a capture particle/SERS nanotag detection particle complex;
concentrating the capture particle/SERS nanotag detection particle complex; and
detecting the Raman spectrum of a Raman reporter molecule associated with the SERS nanotag detection particles.

14. The method of claim 13 wherein the binding reaction kinetics are accelerated by at least one of the following methods; subjecting the sample to microwave radiation, heating the sample, agitating the sample, mixing the sample and vibrating the sample.

15. The method of claim 14 wherein the association reaction kinetics are accelerated by subjecting the sample to microwave radiation having a frequency of greater than 2.45 GHz.

16. The method of claim 14 wherein the association reaction kinetics are accelerated by subjecting the sample to microwave radiation having a frequency of greater than 8.0 GHz.

17. A method for detecting an analyte of interest comprising:
providing capture particles conjugated with a first molecule capable of selectively binding said analyte;
providing SERS nanotag detection particles conjugated with a second molecule capable of selectively binding said analyte;
contacting a sample which may contain the analyte of interest with the capture and detection particles;
accelerating binding reaction kinetics within the sample thereby forming a 2-particle complex from capture particles and detection particles bound to the analyte;
concentrating the 2 particle complex; and
detecting the Raman spectrum of a Raman reporter molecule associated with the SERS nanotag.

18. The method of claim 17 wherein the binding reaction kinetics are accelerated by at least one of the following methods; subjecting the sample to microwave radiation, heating the sample, agitating the sample, mixing the sample and vibrating the sample.

19. The method of claim 18 wherein the association reaction kinetics are accelerated by subjecting the sample to microwave radiation having a frequency of greater than 2.45 GHz.

20. The method of claim 18 wherein the association reaction kinetics are accelerated by subjecting the sample to microwave radiation having a frequency of greater than 8.0 GHz.

21. A method of detecting a nucleotide of interest comprising:
providing a capture probe comprising a capture sequence conjugated to a magnetic particle;
providing a detection probe comprising a detection sequence conjugated to a SERS nanotag;
hybridizing the capture probe and detection probe in the presence of the nucleotide of interest while accelerating hybridization reaction kinetics; and
detecting the Raman spectrum of a Raman reporter molecule associated with the SERS nanotag.

22. The method of claim 21 wherein the hybridization reaction kinetics are accelerated by at least one of the following methods; subjecting the sample to microwave radiation, heating the sample, agitating the sample, mixing the sample and vibrating the sample.

23. The method of claim 22 wherein the association reaction kinetics are accelerated by subjecting the sample to microwave radiation having a frequency of greater than 2.45 GHz.

24. The method of claim 22 wherein the association reaction kinetics are accelerated by subjecting the sample to microwave radiation having a frequency of greater than 8.0 GHz.
